(19) United States
(12) Patent Application Publication
(10) Pub. No.: US 2025/0319458 A1
(43) Pub. Date: Oct. 16, 2025

(54) METAL ION-DOPED TIN DISULFIDE NANOFLOWER AND APPLICATION THEREOF IN PIEZOELECTRIC CATALYTIC DEGRADATION OF POLLUTANTS

(71) Applicant: SOOCHOW UNIVERSITY, Suzhou (CN)

(72) Inventors: Jianmei LU, Suzhou (CN); Najun LI, Suzhou (CN)

(21) Appl. No.: 18/570,193

(22) PCT Filed: Jun. 27, 2021
(86) PCT No.: PCT/CN2021/102590

§ 371 Date: May 30, 2024

(51) Int. Cl. B01J 27/04; B01J 35/33; B01J 37/04; B01J 37/06; C01G 19/00; C02F 1/28; C02F 1/36; C02F 101/34

(52) U.S. Cl. CPC B01J 27/04; B01J 35/33; B01J 37/04; B01J 37/06; C01G 19/00; C02F 1/288; C02F 1/36; C01P 2004/03; C02F 1/281; C02F 2101/345

(57) ABSTRACT

The present disclosed a metal ion-doped tin disulfide nanoflower and application thereof in piezoelectric catalytic degradation of pollutants. A metal salt is placed in a precursor solution containing a tin source and a sulfur source, centrifugal washing is performed after a solvothermal reaction, and drying is performed to obtain a metal ion-doped tin disulfide nanoflower. In the present invention, a copper or silver ion-doped tin disulfide nanoflower is prepared by means of a simple solvothermal method, and applied to the field of piezoelectric catalysis for the first time; the nanosheet morphology and doping synergistically improve the sensitivity of the material to sense mechanical energy and improve the piezoelectric property, thereby improving the catalytic performance. The purpose of catalytic degradation of phenolic organic pollutants in water is achieved by ultrasonic treatment without light.

### TECHNICAL FIELD

The present invention belongs to the field of inorganic nano materials and piezoelectric, and specifically relates to the preparation method of copper/silver ion doped tin disulfide nanoflower and application thereof in piezoelectric catalytic degradation of pollutants.

### BACKGROUND

Environmental pollution and resource shortage are currently two major challenges facing humanity. Photocatalysis is considered an effective means to solve these two major problems, which relies on electrons and holes with oxidation-reduction ability. However, the recombination of electrons and holes generated by illumination is relatively severe. Existing technology has disclosed the application of tin disulfide/carbon nanofiber in the degradation of organic pollutants. Specifically, a piece of carbon nanofiber membrane was placed in a precursor solution containing tin and sulfur sources, followed by solvent thermal reaction, washing and drying to obtain tin disulfide/carbon nanofiber membrane, which was used to Piezoelectric catalytic degradation of organic pollutants under ultrasound. However, the complete degradation was achieved in 120 min.

### SUMMARY OF THE INVENTION

### Technical Problems

The invention provides a preparation method of copper/silver ion doped tin disulfide nanoflower and application thereof in piezoelectric catalytic degradation of pollutants, which realizes the purpose of catalytically degrading phenolic organic pollutants in water bodies through ultrasonic treatment without light.

### Solutions to the Problem

### Technical Solution

To achieve the above objective, the technical solution of the present invention is as follows: the application of metal ion-doped tin disulfide nanoflower in piezoelectric catalytic degradation of pollutants.

A method for metal ion doped tin disulfide nanoflowers in the degradation of organic pollutants comprises the following steps: metal ion-doped tin disulfide nanoflowers are dispersed in a solution containing organic pollutants, and then turn on the ultrasonic machine for Piezoelectric catalytic degradation of organic pollutants.

In the present invention, ionic dopants include Cu ions and Ag ions.

In the present invention, pure SnS₂ nanoflowers were obtained by solvothermal reaction of tin source and sulfur source, followed by washing and drying the products.

In the present invention, metal salt was dissolved in a precursor solution containing tin source and sulfur source, centrifugally washed after solvothermal reaction, and then dried to obtain metal ion doped SnS₂ nanoflowers; Specifically, the copper source was dissolved in the precursor solution containing tin source and sulfur source, centrifugally washed after solvothermal reaction, and then dried to obtain copper ion doped SnS₂ nanoflowers. The silver source was dissolved in the precursor solution containing tin source and sulfur source, centrifugally washed after solvothermal reaction, and dried to obtain silver ion doped SnS₂ nanoflowers.

In the present invention, pure SnS₂, copper ion doped SnS₂ (Cu—SnS₂) and silver ion doped SnS₂ (Ag—SnS₂) were prepared by simple solvothermal reaction. The copper ion or silver ion doped SnS₂ nanoflowers provided by the invention improves the utilization rate of free carriers, and promote the separation of free carriers to achieve piezoelectric reaction without light.

In the present invention, tin tetrachloride pentahydrate (SnCl₄·5H₂O) was used as the tin source, thioacetamide (CH₃CSNH₂) was used as the sulfur source, which were dissolved in anhydrous ethanol to obtain a precursor solution containing both sulfur and tin sources; the molar ratio of SnCl₄·5H₂O to CH₃CSNH₂ was 1:(1-10), such as 1:1-1:8. Preferably, the molar ratio of SnCl₄·5H₂O to CH₃CSNH₂ was 1:4.

In the present invention, the solvothermal reaction was carried out in a Teflon-lined autoclave at 100-160° C. for 6-24 hours, with the preferred condition being 12 hours at 120° C.

In the present invention, copper ion doped SnS₂ nanoflowers (Cu—SnS₂) were prepared by adding copper source as the dopant on the basis of the preparation method of pure SnS₂ nanoflowers. Specifically, copper nitrate trihydrate (Cu (NO₃)₂·3H₂O) was selected as the copper source, with a molar fraction of copper ions relative to tin ions ranging from 1% to 15%, preferably from 3% to 6%.

In the present invention, silver ion doped SnS₂ nanoflowers (Ag—SnS₂) were prepared by adding silver source as dopant on the basis of the preparation method of pure SnS₂ nanoflowers. Specifically, silver nitrate (AgNO₃) was selected as the silver source, with a molar fraction of silver ions relative to tin ions ranging from 1% to 15%, preferably from 3% to 6%.

In the present invention, the frequency of ultrasonic processing was 40-60 KHz, the power was 400-800 W, preferably 45 KHz, 600 W. Furthermore, ultrasound treatment is performed under completely dark conditions.

### BENEFICIAL EFFECTS OF THE INVENTION

### Beneficial Effects

In the present invention, an internal electric field can be constructed by piezoelectric effect of metal ion-doped tin disulfide to achieve effective separation of charge carriers and improve the efficiency of piezoelectric. A simple solvothermal method was used to prepare copper or silver ion doped SnS₂ nanoflowers (Cu—SnS₂, Ag—SnS₂), which were applied for piezoelectric for the first time. The nanosheet structure and doping synergistically improve the sensitivity of catalyst to receive mechanical energy, thus enhance catalytic performance.

### BRIEF DESCRIPTION OF THE DRAWINGS

FIG. 1 The scanning electron microscope (SEM) image of pure SnS₂ nanoflowers.

FIG. 2 The scanning electron microscope (SEM) image of 3% Cu—SnS₂ nanoflowers.

FIG. 3 The scanning electron microscope (SEM) image of 3% Ag—SnS₂ Nanoflowers.

FIG. 4 The performance of piezocatalytic degradation of bisphenol Aby SnS₂, Cu—SnS₂, Ag—SnS₂.

### DISCLOSURE OF INVENTION

### Examples of the Invention

In the present invention, pure SnS₂ nanoflowers, copper ion or silver ion doped SnS₂ nanoflowers (Cu—SnS₂, Ag—SnS₂), which were prepared by a simple solvothermal method, can realize the purpose of degradation of water pollutants without light. The copper ion or silver ion doped SnS₂ nanoflowers improves the utilization rate of free carriers, and realizes piezoelectric reaction efficiently. In the present invention, the molar fraction of copper or silver ions relative to tin ions is measured in percentiles.

### Example 1

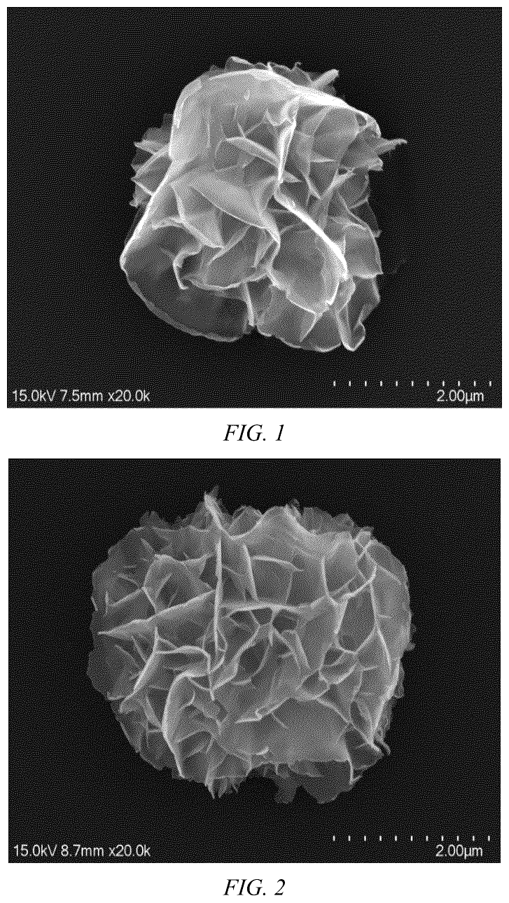

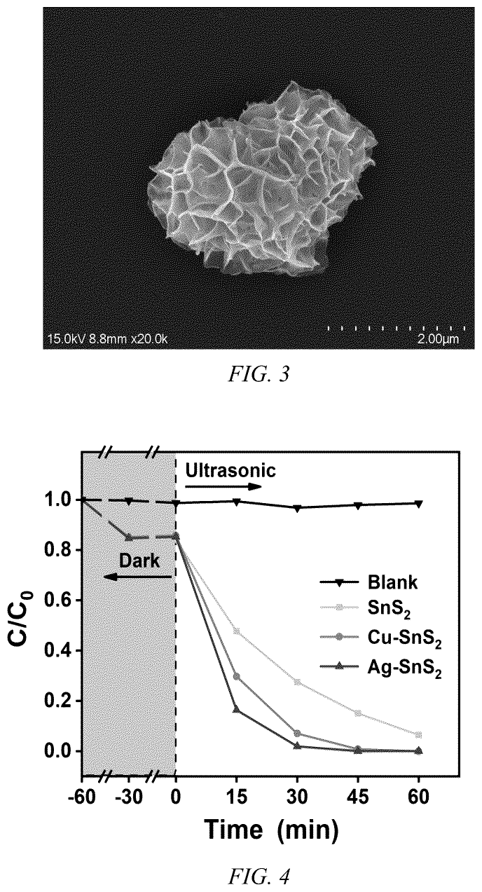

The preparation of pure SnS₂ nanoflowers: a molar ratio of SnCl₄·5H₂O to CH₃CSNH₂ was 1:4. 0.5 mmol (175.3 mg) of SnCl₄·5H₂O and 2 mmol (150.0 mg) of CH₃CSNH₂ were dissolved in 20 mL of anhydrous ethanol, respectively. Then the two solutions were mixed evenly and poured into a 50 mL Teflon-lined autoclave, which was heated to 120° C. for 12 hours. The products obtained after the reaction was washed three times with deionized water and ethanol, followed by drying at 60° C. for 12 hours to obtain SnS₂ nanoflowers. FIG. 1 shows the SEM image of the above pure SnS₂ nanoflowers, which forms a nanoflower shape by interpenetrating large nanosheets.

### Example 2: % Cu—SnS₂ Nanoflowers

The preparation of nanoflowers, the specific steps: a molar fraction of copper ions was 3% of Sn⁴⁺. 0.015 mmol (3.62 mg) Cu (NO₃)₂·3H₂O was dissolved in 5 mL of anhydrous ethanol, 0.48 mmol (170.0 mg) SnCl₄·5H₂O was dissolved in 15 mL of anhydrous ethanol, and 150 mg (2 mmol) CH₃CSNH₂ was dissolved in 20 mL of anhydrous ethanol. The above three solutions were mixed evenly and poured into a 50 mL Teflon-lined autoclave, which was heated to 120° C. for 12 hours. The products obtained after the reaction was washed three times with deionized water and ethanol, followed by drying at 60° C. for 12 hours to obtain Cu—SnS₂ nanoflowers. FIG. 2 shows the SEM image of the above Cu—SnS₂ nanoflowers. It can be seen from the image that the morphology of SnS₂ has not changed significantly due to the doped of copper ions, and it remains in the shape of nanoflower.

### Example 3: 6% Cu—SnS₂

The preparation of nanoflowers, the specific steps: a molar fraction of copper ions was 6% of Sn⁴⁺. 0.03 mmol (7.25 mg) Cu (NO₃)₂·3H₂O was dissolved in 5 mL of anhydrous ethanol, 0.47 mmol (164.8 mg) SnCl₄·5H₂O was dissolved in 15 mL of anhydrous ethanol, and 150 mg (2 mmol) CH₃CSNH₂ was dissolved in 20 mL of anhydrous ethanol. The above three solutions were mixed evenly and poured into a 50 mL Teflon-lined autoclave, which was heated to 120° C. for 12 hours. The products obtained after the reaction was washed three times with deionized water and ethanol, followed by drying at 60° C. for 12 hours to obtain 6% Cu—SnS₂ nanoflowers.

### Example 4: 9% Cu—SnS₂

The preparation of nanoflowers, the specific steps: a molar fraction of copper ions was 9% of Sn⁴⁺. 0.045 mmol (10.87 mg) Cu (NO₃)₂·3H₂O was dissolved in 5 mL of anhydrous ethanol, 0.455 mmol (159.5 mg) SnCl₄·5H₂O was dissolved in 15 mL of anhydrous ethanol, and 150 mg (2 mmol) CH₃CSNH₂ was dissolved in 20 mL of anhydrous ethanol. The above three solutions were mixed evenly and poured into a 50 mL Teflon-lined autoclave, which was heated to 120° C. for 12 hours. The products obtained after the reaction was washed three times with deionized water and ethanol, followed by drying at 60° C. for 12 hours to obtain 9% Cu—SnS₂ nanoflowers.

### Example 5: 12% Cu—SnS₂

The preparation of nanoflowers, the specific steps: a molar fraction of copper ions was 12% of Sn⁴⁺. 0.06 mmol (14.5 mg) Cu (NO₃)₂·3H₂O was dissolved in 5 mL of anhydrous ethanol, 0.44 mmol (154.3 mg) SnCl₄·5H₂O was dissolved in 15 mL of anhydrous ethanol, and 150 mg (2 mmol) CH₃CSNH₂ was dissolved in 20 mL of anhydrous ethanol. The above three solutions were mixed evenly and poured into a 50 mL Teflon-lined autoclave, which was heated to 120° C. for 12 hours. The products obtained after the reaction was washed three times with deionized water and ethanol, followed by drying at 60° C. for 12 hours to obtain 12% Cu—SnS₂ nanoflowers.

### Example 6: 1% Ag—SnS₂

The preparation of nanoflowers, the specific steps: a molar fraction of silver ions was 1% of Sn⁴⁺. 0.005 mmol (0.85 mg) AgNO₃ was dissolved in 5 mL of anhydrous ethanol, 0.495 mmol (173.6 mg) SnCl₄·5H₂O was dissolved in 15 mL of anhydrous ethanol, and 150 mg (2 mmol) CH₃CSNH₂ was dissolved in 20 mL of anhydrous ethanol. The above three solutions were mixed evenly and poured into a 50 mL Teflon-lined autoclave, which was heated to 120° C. for 12 hours. The products obtained after the reaction was washed three times with deionized water and ethanol, followed by drying at 60° C. for 12 hours to obtain 1% Ag—SnS₂ nanoflowers.

### Example 7: 3% Ag—SnS₂

The preparation of nanoflowers, the specific steps: a molar fraction of silver ions was 3% of Sn⁴⁺. 0.015 mmol (2.55 mg) AgNO₃ was dissolved in 5 mL of anhydrous ethanol, 0.48 mmol (170.0 mg) SnCl₄·5H₂O was dissolved in 15 mL of anhydrous ethanol, and 150 mg (2 mmol) CH₃CSNH₂ was dissolved in 20 mL of anhydrous ethanol. The above three solutions were mixed evenly and poured into a 50 mL Teflon-lined autoclave, which was heated to 120° C. for 12 hours. The products obtained after the reaction was washed three times with deionized water and ethanol, followed by drying at 60° C. for 12 hours to obtain 3% Ag—SnS₂ nanoflowers. FIG. 2 shows the SEM image of the above Ag—SnS₂ nanoflowers. It can be seen from the image that the size of the nanosheets is significantly reduced due to the doped of silver ions, but the morphology of nanoflower is still maintained.

### Example 8: 6% Ag—SnS₂

The preparation of nanoflowers, the specific steps: a molar fraction of silver ions was 6% of Sn⁴⁺. 0.03 mmol (5.10 mg) AgNO₃ was dissolved in 5 mL of anhydrous ethanol, 0.47 mmol (164.8 mg) SnCl₄·5H₂O was dissolved in 15 mL of anhydrous ethanol, and 150 mg (2 mmol) CH₃CSNH₂ was dissolved in 20 mL of anhydrous ethanol. The above three solutions were mixed evenly and poured into a 50 mL Teflon-lined autoclave, which was heated to 120° C. for 12 hours. The products obtained after the reaction was washed three times with deionized water and ethanol, followed by drying at 60° C. for 12 hours to obtain 6% Ag—SnS₂ nanoflowers.

### Example 9: 9% Ag—SnS₂

The preparation of nanoflowers, the specific steps: a molar fraction of silver ions was 9% of Sn⁴⁺. 0.045 mmol (7.64 mg) AgNO₃ was dissolved in 5 mL of anhydrous ethanol, 0.455 mmol (159.5 mg) SnCl₄·5H₂O was dissolved in 15 mL of anhydrous ethanol, and 150 mg (2 mmol) CH₃CSNH₂ was dissolved in 20 mL of anhydrous ethanol. The above three solutions were mixed evenly and poured into a 50 mL Teflon-lined autoclave, which was heated to 120° C. for 12 hours. The products obtained after the reaction was washed three times with deionized water and ethanol, followed by drying at 60° C. for 12 hours to obtain 9% Ag—SnS₂ nanoflowers.

### Example 10: 12% Ag—SnS₂

The preparation of nanoflowers, the specific steps: a molar fraction of silver ions was 12% of Sn⁴⁺. 0.06 mmol (10.19 mg) AgNO₃ was dissolved in 5 mL of anhydrous ethanol, 0.44 mmol (154.3 mg) SnCl₄·5H₂O was dissolved in 15 mL of anhydrous ethanol, and 150 mg (2 mmol) CH₃CSNH₂ was dissolved in 20 mL of anhydrous ethanol. The above three solutions were mixed evenly and poured into a 50 mL Teflon-lined autoclave, which was heated to 120° C. for 12 hours. The products obtained after the reaction was washed three times with deionized water and ethanol, followed by drying at 60° C. for 12 hours to obtain 12% Ag—SnS₂ nanoflowers.

### Example 11

Piezoelectric catalytic degradation of bisphenol A (BPA) by SnS₂: 6 mg SnS₂ was dispersed into BPA aqueous solution (10 mL, 10 mg/L) in a small beaker. Prior to the degradation, the mixture was stirred for 1 h in dark to get adsorption/desorption equilibrium. Then the mixture was transferred to a glass tube and fixed in center of ultrasonic cleaner. After that, ultrasound (600 W, 45 KHz) was provided and 800 μL of suspension was collected after filtering with a 0.22 μm water-based filter every 15 min. The concentration of residual BPA was determined by HPLC which deionized water and ethanol mixed with 3:7 as mobile phase. The absorption curve of at 290 nm UV wavelength was tested, and the peak area of BPA was recorded at around 6 minutes. The initial concentration of BPA was recorded as 100%, resulting in a Piezoelectric catalytic degradation curve of BPA.

### Example 12

Piezoelectric catalytic degradation of BPA by SnS₂ doped with different levels of copper ions: 6 mg Cu—SnS₂ (3%, 6%, 9%, and 12%) was dispersed into BPA aqueous solution (10 mL, 10 mg/L) in a small beaker. Prior to the degradation, the mixture was stirred for 1 h in dark to get adsorption/desorption equilibrium. Then the mixture was transferred to a glass tube and fixed in center of ultrasonic cleaner. After that, ultrasound (600 W, 45 KHz) was provided and 800 μL of suspension was collected after filtering with a 0.22 μm water-based filter every 15 min. The concentration of residual BPA was determined by HPLC which deionized water and ethanol mixed with 3:7 as mobile phase. The absorption curve of at 290 nm UV wavelength was tested, and the peak area of BPA was recorded at around 6 minutes. The initial concentration of BPA was recorded as 100%, resulting in a Piezoelectric catalytic degradation curve of BPA.

### Example 13

Piezoelectric catalytic degradation of BPA by SnS₂ doped with different levels of silver ions: 6 mg Ag—SnS₂ (3%, 6%, 9%, and 12%) was dispersed into BPA aqueous solution (10 mL, 10 mg/L) in a small beaker. Prior to the degradation, the mixture was stirred for 1 h in dark to get adsorption/desorption equilibrium. Then the mixture was transferred to a glass tube and fixed in center of ultrasonic cleaner. After that, ultrasound (600 W, 45 KHz) was provided and 800 μL of suspension was collected after filtering with a 0.22 μm water-based filter every 15 min. The concentration of residual BPA was determined by HPLC which deionized water and ethanol mixed with 3:7 as mobile phase. The absorption curve of at 290 nm UV wavelength was tested, and the peak area of BPA was recorded at around 6 minutes. The initial concentration of BPA was recorded as 100%, resulting in a Piezoelectric catalytic degradation curve of BPA.

FIG. 4 shows the Piezoelectric catalytic degradation efficiency of BPA by SnS₂, 3% Cu—SnS₂, and 3% Ag—SnS₂. The degradation rate of BPA is almost negligible without the catalyst. After providing ultrasonic vibration, the degradation rates of BPA by SnS₂, 3% Cu—SnS₂, and 3% Ag—SnS₂ are about 60%, 70%, and 84% in 15 min, respectively. Ag—SnS₂ showed the highest degradation efficiency and the degradation rate is 100% in 45 min. The degradation rate can be 99% by 3% Cu—SnS₂ in 45 min and 100% in 60 min.

In the experiment of degradation BPA mentioned above, turning on ultrasound in dark was changed to 300 W xenon lamp irradiation (only illumination), while the rest remained unchanged. It was found that SnS₂, 3% Cu—SnS₂, and 3% Ag—SnS₂ didn't show catalytic activity for degradation of BPA. What's more, additional light did not improve the piezoelectric activity.

According to the conventional method, the slope of the kinetic equation obtained from the degradation curve was linearly fitted to obtain the apparent reaction rate constant k. Tables 1 and 2 list the apparent reaction rate constant k values for the degradation of BPA by SnS₂ doped with different levels of metal ions. According to Table 1, 6% Cu—SnS₂ shows the highest k value (0.1004 min⁻¹) and the degradation rate. In Table 2, 3% Ag—SnS₂ presents the highest k value (0.1231 min⁻¹) and the fastest degradation rate, which is higher than the apparent reaction rate constant of 6% Cu—SnS₂.

TABLE 1
The apparent reaction rate constant k of degradation BPA
by SnS₂ doped with different doping levels of copper ions

| | Doping level of copper ions | | | | |
|---|---|---|---|---|---|
| | 0% | 3% | 6% | 9% | 12% |
| k (min⁻¹) | 0.0726 | 0.0877 | 0.1004 | 0.0783 | 0.0471 |

TABLE 2
The apparent reaction rate constant k of degradation BPA
by SnS2 doped with different doping levels of silver ions

| | Doping level of silver ions | | | | |
|---|---|---|---|---|---|
| | 0% | 3% | 6% | 9% | 12% |
| k (min⁻¹) | 0.0726 | 0.0819 | 0.1231 | 0.0877 | 0.0425 |

### Comparative Example 1

Taken the 6 mg 3% Ag—SnS₂ in Example 13 by the 0.5 SnS₂/CNFs (6 mg) composite material prepared in Example 3 of CN202010815126X, with the remaining unchanged, as a comparative experiment. The results showed that the degradation rate of BPA was 62% in 15 min, 88% in 45 min, and 95% in 60 min under ultrasonic vibration.

### Comparative Example 2

Silver nanoparticles were deposited on the surface of SnS₂ nanoflowers by photoreduction. 0.5 g of SnS₂ was dispersing in a beaker containing 25 mL AgNO₃ solution (0.02M). The mixture was irradiated by a UV lamp under continuous stirring, and then separated the powder through a centrifuge, wash and dry it at room temperature to obtain SnS₂ nanoflowers deposited by silver nanoparticles. Replacing the 6 mg 3% Ag—SnS₂ in Example 13 by 6 mg SnS₂ nanoflowers deposited by silver nanoparticles, with the remaining unchanged, as a comparative experiment. The results show that the removal rate of BPA was 50% in 15 min, 72% in 45 min, and 87% in 60 min.

### Example 14

Replacing the copper salt with copper acetate monohydrate (Cu (CO₂CH₃)₂·H₂O) did not significantly affect the catalytic performance. The removal rate of BPA by 3% Cu—SnS₂ prepared according to the method in Example 2 was 97.3% in 45 min.

The present invention discloses a preparation method for inorganic nonmaterial, which can degrade organic pollutants in water by mechanical energy vibration. The central symmetry of crystal structure is a key factor affecting piezoelectric properties, and ion doping is currently a feasible approach to improving piezoelectric properties. In the present invention, a simple and effective element doping strategy was developed. Specifically, Cu (r=77 pm) and Ag (r=115 pm) were used as dopant because of significant differences in the ionic radius compared to Sn⁴⁺ (r=69 pm) to improve the piezoelectricity of SnS₂ and the formation of amorphous synergistically improve the piezoelectric performance.

1. A metal ion-doped tin disulfide nanoflower, characterized in that a molar fraction of copper ions relative to tin ions ranging from 1% to 15%.

2. The metal ion-doped tin disulfide nanoflower according to claim 1, wherein the metal ion-doped tin disulfide nanoflower is a copper ion- or silver ion-doped tin disulfide nanoflower.

3. The metal ion-doped tin disulfide nanoflower according to claim 1, wherein a metal salt is dissolved in a precursor solution containing a tin source and a sulfur source, centrifugally washed after a solvothermal reaction, and then dried to obtain the metal ion-doped tin disulfide nanoflower.

4. An application of a metal ion-doped tin disulfide nanoflower in the degradation of organic pollutants.

5. The application of the metal ion-doped tin disulfide nanoflower in the degradation of organic pollutants according to claim 4, wherein the degradation is performed under ultrasound.

6. A method for applying a metal ion-doped tin disulfide nanoflower in the degradation of organic pollutants, comprising the following steps: dispersing the metal ion-doped tin disulfide nanoflower in a solution containing organic pollutants, and then turning on an ultrasonic machine for Piezoelectric catalytic degradation of the organic pollutants.

7. The method for applying the metal ion doped tin disulfide nanoflowers in the degradation of organic pollutants according to claim 6, wherein a metal salt is dissolved in a precursor solution containing a tin source and a sulfur source, centrifugally washed after a solvothermal reaction, and then dried to obtain the metal ion-doped tin disulfide nanoflower.

8. The method for applying the metal ion doped tin disulfide nanoflower in the degradation of organic pollutants according to claim 6, wherein the solvothermal reaction is carried out at 100-160° C. for 6-24 hours.

9. The method for applying the metal ion doped tin disulfide nanoflower in the degradation of organic pollutants according to claim 6, wherein a molar ratio of the tin source to the sulfur source is 1:(1-10).

10. The method for applying the metal ion doped tin disulfide nanoflower in the degradation of organic pollutants according to claim 6, wherein a frequency of ultrasonic processing is 40-60 KHz, a power is 400-800 W.
